(19) United States
(12) Patent Application Publication
(10) Pub. No.: US 2018/0021605 A1
(43) Pub. Date: Jan. 25, 2018

(54) COAL MINER PERSONAL AIR FILTRATION SYSTEM SPECIALLY ADAPTED FOR LOW CEILING MINES

(71) Applicant: Mark A. Bartkoski, Zanesville, OH (US)

(72) Inventor: Mark A. Bartkoski, Zanesville, OH (US)

(21) Appl. No.: 15/218,484

(22) Filed: Jul. 25, 2016

(51) Int. Cl. A62B 9/04; A41D 1/04; A62B 18/02; A62B 7/12; A62B 7/10; A62B 18/00

(52) U.S. Cl. CPC A62B 9/04; A62B 7/10; A62B 18/006; A62B 18/02; A62B 7/12; A41D 1/04

(57) ABSTRACT

A positive pressure personal air filtration system particularly advantageous in the close quarters of a low ceiling mine. An air pump and air filter unit is mounted to a vest worn by a user and is connected to a nose and mouth mask by an air hose which, if the unit is mounted to the back of the vest, passes directly over the user's shoulder. The mask has upper and side edges contoured to seat against the user's face from immediately above the user's nose and extending down the user's cheeks. The mask extends further downward to a bottom termination edge which is contoured to extend in spaced relationship out in front of the user's face to define a non-valved opening to ambient air across the entire bottom of the mask. The termination edge extends downward to a lower level than the user's mouth and preferably to the level of the user's chin to form an air reservoir.

### BACKGROUND OF THE INVENTION

This invention relates generally to a personal air filtration system that is worn by a user and more particularly relates to personal air filtration apparatus that has structural features that make it specially adapted and advantageous for use in low ceiling mines and restricted clearance areas.

There are many industrial environments in which the ambient air is unsafe for human respiration. Workers in some of those environments often use a personal air filtration apparatus for removing contaminants in the ambient air. Many such devices that are commonly in use have an air pump which draws in the ambient air, forces it through a filter and conducts the filtered air through a hose to a respirator worn on the face of the user.

Coal mines present a significant air quality problem because the interior of coal mines is a confined air space with air borne irritants, particularly coal dust and other particulates such as silica. There are commercially available systems that work well in many environments, including in many coal mining environments. However, the prior art appears to have not recognized that low ceiling mines present special problems and limitations that are not present in ordinary mines or in many other industrial environments. For example, low ceiling mines can be described as very close quarters because the space available for workers to perform their tasks is very confined and visually limited. The ceiling height is near, and sometimes below, the height of the top of the head of many mine workers. The ceilings and sidewalls have rough textured surfaces with rock or coal protrusions that can easily snag any equipment carried on the body of the mine worker. These protrusions are especially a problem with low ceilings because most people are not accustomed to looking upward to ascertain their physical clearance to a ceiling when moving in the course of doing their work. The closely confined nature of the low ceiling mine environment limits visibility and forces workers to work close to mining machinery. As a result, the personal air filtration equipment that is being worn by coal miners who are physically active, moving and bending in all directions in a low ceiling mine, often strikes mining machinery and the sidewalls and ceiling of the mine. These collisions can displace, dislodge or damage components of the air filtration equipment making the equipment temporarily or permanently inoperable.

The most commonly used personal air filtration device for mines has its pump, pump drive motor and filter all mounted inside an enlarged helmet or hard hat. This device draws air from behind the user's neck, conveys the air over top of the individual's head to a filter and then to a full face mask. This device also weighs three and a half pounds. As a result, this device protrudes upward about two inches above the normal sized hard hat. Consequently, even if a miner is aware that he has two inches of ceiling clearance, it is difficult to remember that a few inches of clearance above the top of his head is insufficient. So this prior art device often strikes the ceiling in a low ceiling mine causing discomfort and distraction and increasing the risk of neck injuries.

Although this commonly used air filtration device does work well in a high ceiling mine (at least 7 ft), most mines do not have such heights. If a miner is working in a low ceiling mine and is located near a cutting operation or other operation that uses a water spray for cooling, there is residual spray and mist entrained in the ambient air. The current prior art alternative mandates an integral face shield which allows fogging on the inside and spray droplets on the outside of the mask which inhibits the ability of the miner to see and is uncomfortable or even irritating.

There are several other problems associated with devices of this type. Because the pump motor is mounted to the hard hat within three inches of the ears of the miner, the motor generates a noise that is loud for the user who is wearing the device. The component parts mounted to the hard hat make the entire device six inches longer than a conventional hard hat making it nearly impossible for the miner to bend his neck back to look upward. Not only is this device bulky, but its weight of three and a half pounds is heavy for a miner, who is often bending over in a low ceiling coal mine, which causes the miner's neck and back to become tired.

This commonly used device is also large and bulky so miners put it in a bag and carry it into the mine and put it on after arriving at their worksite inside the mine. Because this prior art device has a full face mask, it is uncomfortable and restricts visibility and the peripheral vision of the miner, the miner cannot eat anything or talk to other miners with it on and the miner cannot wear some prescription eye glasses.

Another type of personal air filtration device has its pump, pump motor and filter mounted to the belt of the user behind the user's back. Its hose extends upward from its outlet immediately above the user's belt to an air inlet in the rear of the user's hard hat. Similar devices have their air hose extending from above the belt up and over the shoulder of the user to a mask on the user's face. In both cases the air hose makes a free, large loop behind and extending away from the user's back. Personal air filtration equipment with such exposed and protruding air hose loops, that extend along the relatively long path from the user's belt or back to a mask, have a relatively long air hose that is openly exposed and unprotected from striking or catching on surrounding objects.

Yet another type of personal air filtration device is a negative pressure system which relies on a pressure drop when the miner inhales to admit air into the mask. But with these devices the eyepieces and a miner's glasses become fogged up and they also become uncomfortably hot on the miner's face.

### BRIEF SUMMARY OF THE INVENTION

The invention is a positive pressure personal air filtration system having an air pump and air filter mounted to a user's vest and capable of forcing filtered ambient air through a hose to a nose and mouth mask. The mask has upper and side edges contoured to seat against the user's face immediately above the user's nose and down the user's cheeks. The mask extends downward to a bottom termination edge that is contoured to extend in spaced relationship from the face of the user to define a non-valved bottom opening of the mask to ambient air. This termination edge extends downward to a lower level than the mouth of the user to form an air reservoir. The open bottom of the mask permits the filtered air to flow directly across the user's nose and mouth and providing several advantageous functional advantages. Additional structural features and functional improvements afforded by embodiments of the invention are described below.

### BRIEF DESCRIPTION OF THE SEVERAL VIEWS OF THE DRAWINGS

FIG. 1 is a view in perspective of an embodiment of the invention mounted in its operable configuration on a user and viewed from the right rear quarter.

FIG. 2 is a view in perspective of the embodiment of FIG. 1 viewed from the right front quarter.

FIG. 3 is a frontal view in perspective of the embodiment of FIG. 1.

FIG. 4 is a front view of the mask of the embodiment of FIG. 1.

FIG. 5 is a side view of the mask of the embodiment of FIG. 1.

FIG. 6 is a rear view of the mask of the embodiment of FIG. 1.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

The invention solves all of the above-described problems that are inherent in low ceiling mine environments by its unique combination of structural features that are specially adapted for that environment. However, the simplicity, compactness, ease of use and the comfort of embodiments of the invention make it also desirable in other environments.

The structural features of the invention will first be described with reference to the drawings and then the advantageous results and improvements provided by those structural features will be explained.

Structure of Apparatus Embodying the Invention

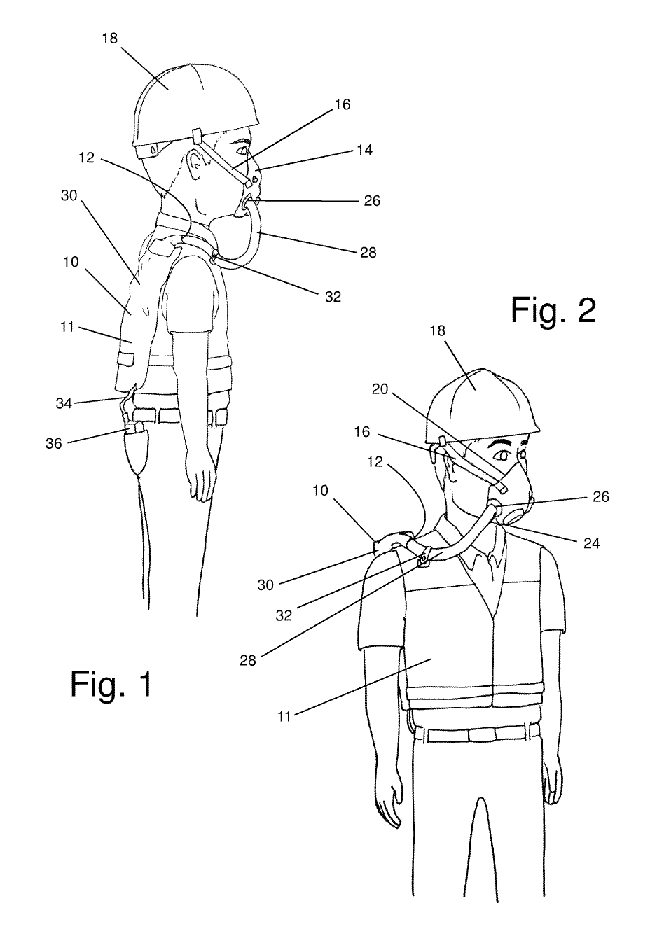

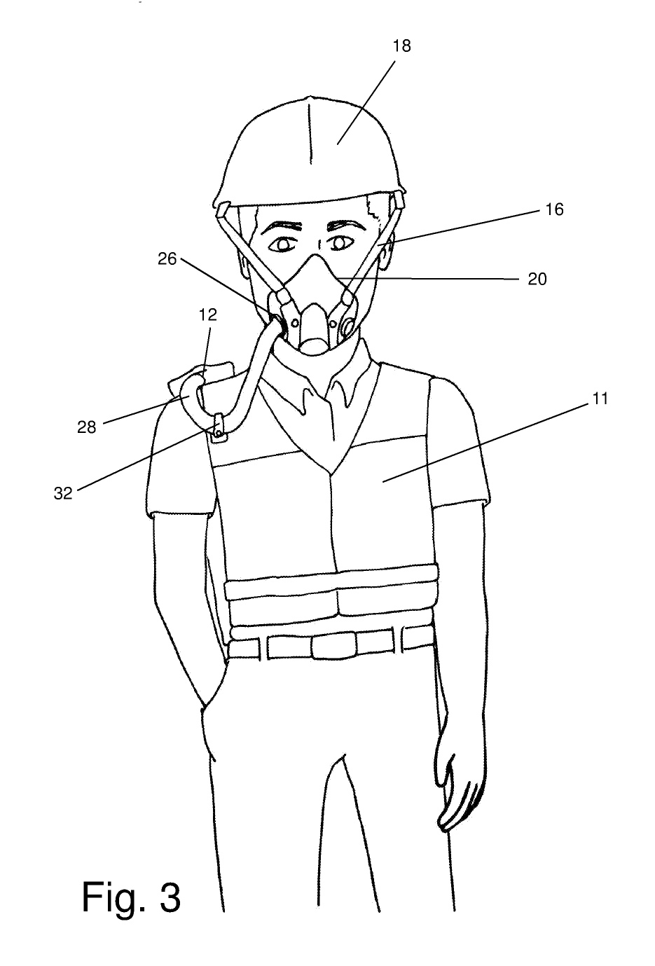

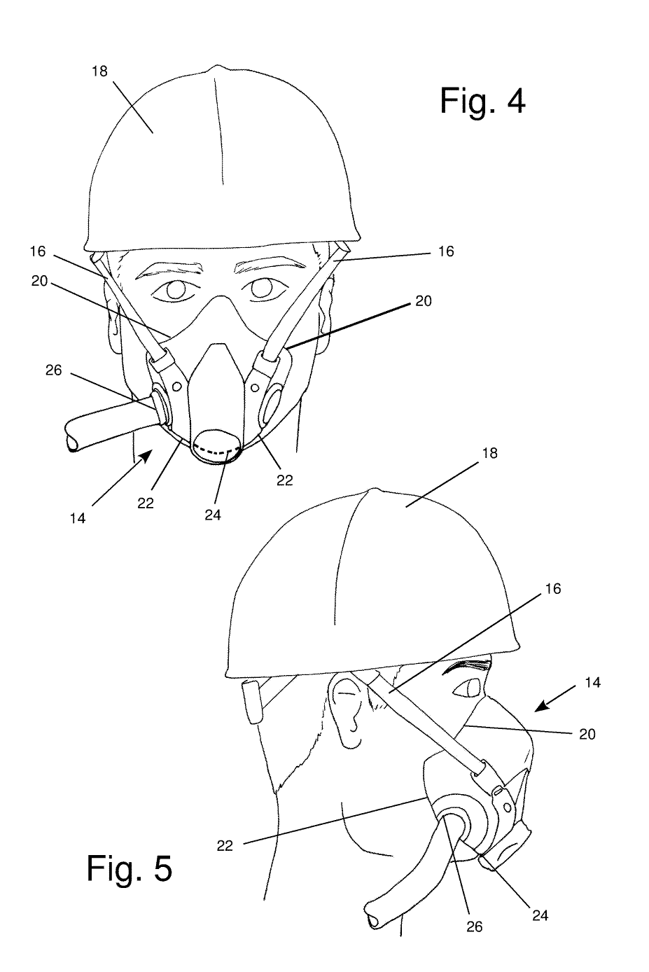

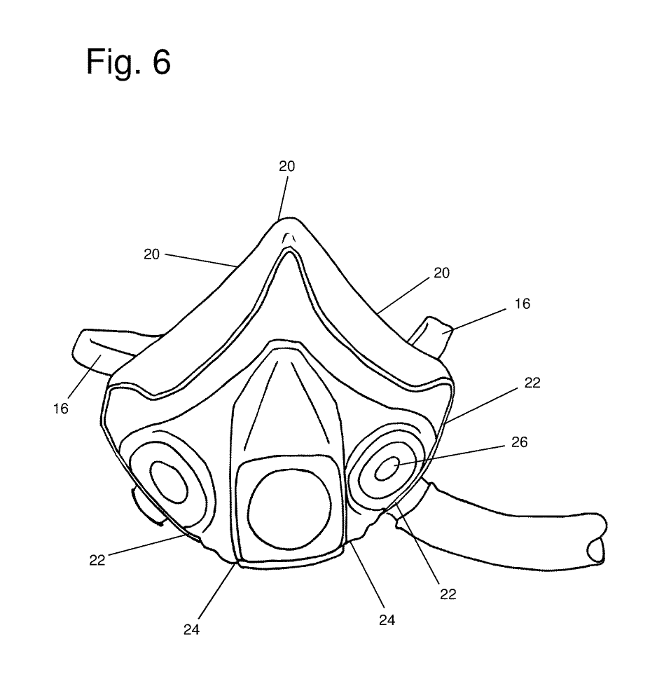

The invention is a positive pressure personal air filtration system that is illustrated in its operable position on a user in FIGS. 1-3. An air pump and air filter combination unit 10 is mounted to a vest 11 that is worn by the user. The term “vest” is used to refer to a garment that is worn on the upper body and is suitable for supporting component parts of the personal air filtration apparatus. A brightly colored safety vest 11 is preferred for worker safety and strength but the “vest” 11 can also include a coat, shirt, suspenders or similar body-mounted garment that has sufficient strength to support the component parts. The “vest” can also be an array of connected straps forming a harness.

The mechanical operating components of the air pump and air filter combination unit 10 are commercially available and well known in the art and therefore their detail is not shown or described any further. The air pump and air filter combination unit 10 functions to draw in ambient air and force the air through its air filter to an outlet port 12.

Importantly, a nose and mouth mask 14, rather than a full face mask, is mounted over the nose and mouth of the user and is supported in that position by a pair of mask support straps 16 that extend on opposite sides of the user's face into connection to the user's hard hat 18. If the user does not wear a hard hat or opts to, an alternative head strap can be used which simply goes around the back of the user's head to anchor the mask 14. The nose and mouth mask 14 has approximately V-shaped upper and side edges 20 that are contoured to seat against the user's face beginning from immediately above the user's nose and continuing down the user's cheeks. The mask 14 extends downward to a bottom termination edge 22. The termination edge 22 is contoured to extend in spaced relationship from the face of the user to define a non-valved opening of the mask 14 to the ambient air at the bottom of the mask 14. The termination edge 22 and its positioning to provide an open space between the termination edge 22 and the face of the user are important features of the invention. The open space or opening between the mask 14 and the user's face provides a gap for the exhaust from the mask 14 of filtered air that is pumped into the mask 14 by the air pump and air filter 10. The termination edge 22 begins approximately 3 inches below the top bridge of the mask, inclines or tapers downwardly away from facial contact to the forward bottom end 24 of the termination edge 22 which is preferably approximately 3 inches below the upper end of the termination edge 22.

The termination edge 22 extends downward so that, at the central bottom edge 24 of the termination edge 22 of the mask 14, the termination edge 22 is at least at a lower level than the mouth of the user and preferably still lower. More desirably, the termination edge 22 extends downward to or below the level of the lower lip of the user. Even more desirably the termination edge 22 extends downward at least to a bottom level between the user's lower lip and bottom of the user's chin and most preferably the termination edge 22 tapers downward and outward away from the face of the user to be spaced at its bottom edge 24 by a distance in the range of ¼ inch to ½ inch forward from the user's chin. This gap between at least the bottom edge 24 of the termination edge 22 and the user's face provides an escape passage for air pumped into the mask.

The mask 14 has an air hose inlet port 26 and an air hose 28 is connected between the outlet port 12 of the air pump and air filter 10 and the inlet port 26 of the mask 14. The air pump and air filter 10 is mounted to the vest 11 with the outlet port 12 located at an upper end of the air pump and air filter 10 and its air inlet located at the bottom of the air pump and air filter 10. The air pump and air filter 10 are preferably housed in a flexible bag 30 that is attached to the vest 11 at a height and orientation to position the outlet port 12 at a shoulder portion of the vest. Attachment can be accomplished by any suitable device but is preferably removably attached so that a user can manually detach the flexible bag 30 along with the air pump and air filter 10 from the vest 11. Examples of suitable attachment devices include manually releasable clamps and hooks and loops fastener straps.

For optimum effectiveness, the flexible bag 30 that contains the air pump and air filter 10 is mounted to a back portion of the vest 11. This location positions the outlet port 12 at a shoulder portion of the vest 11 and immediately behind the shoulder of the user. Consequently, the air hose 28 can extend a very short distance directly forward to the inlet port 26 of the mask. In that position, the air hose 28 is not only short but also it does not loop outward away from the body of the user and catch or snag on nearby protruding objects. Instead, during use the air hose 28 is nested between the user's head and the user's shoulders where it is least likely to catch on a protruding object in the mine. A central portion of the air hose 28 is attached to a shoulder portion of the vest 11 by a manually releasable fastener 32. This further assures that the air hose 28 is retained close to the user's body and away from nearby protruding objects. However, if the user is driving or operating a piece of equipment in a dusty atmosphere, the flexible bag can be strapped or otherwise attached to the front of the vest where is free from contact against a seat back.

An electrical cord 34 (FIG. 1) for supplying battery power to the air pump extends out the bottom of the flexible bag 30 to a battery 36 mounted on a posterior portion of a belt worn by the user. Batteries are typically carried on the belt of a user so the positioning and vertical orientation of the flexible bag 30 also allows the battery power cord 34 to be relatively short and close to the user's body and be protected within the flexible bag 30 without any outwardly extending free loops that can catch on nearby protruding objects.

Operation and Improvements in Function

The bottom of the mask is open between the termination edge 22 and the face of the user. Positive pressure air (greater pressure than the environmental atmospheric pressure) blows freely across the nose and mouth of the user and exhausts out the bottom opening below the termination edge 22. The incoming clean air is continuously blowing any moisture and contaminants out of the mask 14 and into the ambient air. Because the mask is not sealed against the face around its entire periphery and there is no outlet valve and no other restrictions in the air flow path to reduce the air flow rate, the air can flow smoothly and uniformly across the user's nose and mouth. Ambient air cannot enter because of the greater pressure in the face mask. Excess air escapes and the user's nose and mouth can only breathe in filtered air supplied by the system. Because the opening is across the entire width of the mask, the air flows more uniformly across the entire portion of the user's face that is under the mask thereby cooling that entire portion of the face. Because air flow is confined more directly to and around the nose instead of also around the eyes and cheeks of the user, the invention makes more efficient use of the air.

The portion of the mask 14 that is below the user's nose and above the termination edge 22 forms a chamber that acts as an air reservoir immediately below the user's nose. If the user takes a deep breath inhaling air at a higher flow rate than the air is coming into the mask through the hose, air is breathed in from the reservoir instead of from the outside ambient air. Although the pump transports air into the mask at a flow rate that is a little over twice the average flow rate that a person normally breathes, the reservoir can accommodate a few unusually deep breaths.

Because the air is exhausted from the mask below the entire termination edge 22 and therefore immediately below and beside the mouth area, instead of only below the chin as with a full face mask, about 20% of the exhausted air flows sideward and upward out the opening below the termination edge 22 and then flows by convection upward across the user's cheeks and across the user's eyes. This air flow helps cool the face and keeps dust away from the eyes and helps prevent dust deposits on any eyeglasses worn by the user. Because the invention has only a nose and mouth mask, instead of a full face mask, there is no eyeglass fogging problem and no problem fitting eyeglasses on the user.

As seen in the drawings, a typical air pump and air filter 10 is an elongated unit. The air pump and air filter 10 contained within its flexible bag 30 is mounted to the vest 11 in a vertical orientation. Because the air inlet is at the bottom end of the flexible bag 30, the air inlet is well below the ceiling where mist and water droplets from any cooling water spray tends to concentrate. Consequently, the mist and water droplets are not drawn into the air pump and air filter 10. The flexible bag 30 protects the air pump and air filter 10 and helps prevent it from catching on nearby protruding objects.

Of course the mask 14 can be made in different sizes to accommodate variations in human face sizes. Because the invention does not have the air pump and filter or its hose mounted to the hard hat, the filtration system does not cause any protrusions from the hard hat that can strike a mine ceiling or mine equipment and a conventional hard hat can be used. The invention eliminates the need for valves in the mask which add weight, often protrude to provide structures that can catch or snag on surrounding objects and require cleaning. With the invention there is no concern about sealing against the entire face of the user in order to avoid seal leakage. The open bottom allows the user to talk to other people. Users are able to eat something by simply lifting the mask a short distance rather than being required to remove the mask entirely from the user's face. Because the invention is so compact with no structures mounted to and protruding from the hard hat and is conveniently mounted to a vest, a miner is able to put his or her personal air filtration system on in the more comfortable area outside the mine and then wear it into to mine.

Because the air hose 28 is attached to the vest 11 at the user's shoulder, the mask's support straps can be simply unclipped from the hard hat 18 permitting the mask to fall down and hang from the shoulder against the user's chest. So it is easy, quick and convenient for the user to temporarily remove the mask from his or her face and yet the mask hangs safely where it is not likely to catch on anything and can easily and quickly be grasped and replaced on the face. An internal pocket on the vest is also included to store the mask 14 when not in use.

### COMPONENT REFERENCE NUMERALS

air pump and air filter combination unit 10
vest 11
outlet port 12 of the air pump and air filter 10
nose and mouth mask 14
mask support straps 16
hard hat 18
upper and side edges 20 of nose and mouth mask 14
bottom termination edge 22 of nose and mouth mask 14
central bottom edge 24 of the mask 14
air hose inlet port 26 of the mask 14
air hose 28
flexible bag 30
manually releasable fastener 32
electrical cord 34
battery 36

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A positive pressure personal air filtration system comprising:
(a) a vest wearable by a user;
(b) an air pump and air filter mounted to the vest and capable of forcing ambient air through the air filter to an outlet port;
(c) a nose and mouth mask having upper and side edges contoured to seat against the user's face immediately above the user's nose and down the user's cheeks, the mask extending downward to a bottom termination edge, the termination edge contoured to extend in spaced relationship from the face of the user to define a non-valved opening of the mask to ambient air, the termination edge extending downward to a lower level than the mouth of the user, the mask also having an air hose inlet port; and
(d) an air hose connected between the outlet port and the inlet port.

2. A personal air filtration system in accordance with claim 1, wherein the air pump and air filter are mounted to the vest with the outlet port at an upper end of the air pump and air filter.

3. A personal air filtration system in accordance with claim 2 wherein the termination edge extends downward to or below the level of the lower lip of the user.

4. A personal air filtration system in accordance with claim 3 wherein the air pump and air filter are housed in a flexible bag that is attached to the vest with the outlet port at a shoulder portion of the vest.

5. A personal air filtration system in accordance with claim 4 wherein a central portion of the hose is attached to a shoulder portion of the vest by a manually releasable fastener.

6. A personal air filtration system in accordance with claim 4 wherein the flexible bag containing the air pump and air filter is mounted to a back portion of the vest and an electrical cord for supplying battery power to the air pump extends out the bottom of the flexible bag to a battery mounted on a posterior portion of a belt worn by the user.

7. A personal air filtration system in accordance with claim 6 wherein the termination edge extends downward to a bottom level between the user's lower lip and bottom of the user's chin.

8. A personal air filtration system in accordance with claim 4 wherein the termination edge tapers downward and outward away from the face of the user to be spaced at its bottom by a distance in the range of ¼ inch to ½ inch forward from the user's chin.
